(19) United States
(12) Patent Application Publication
(10) Pub. No.: US 2017/0171107 A1
(43) Pub. Date: Jun. 15, 2017

(54) COMMUNICATION METHOD AND THE CLIENT FOR MULTIPLE PROCESSES

(71) Applicants: Le Holdings (Beijing) Co., Ltd., Chao Yang District (CN); Le Shi Internet Information & Technology Corp., Beijing, Chao Yang District (CN)

(72) Inventor: Zanbie Wei, Chao Yang District (CN)

(21) Appl. No.: 15/241,165

(22) Filed: Aug. 19, 2016

Related U.S. Application Data
(63) Continuation of application No. PCT/CN2016/089564, filed on Jul. 10, 2016.

(30) Foreign Application Priority Data
Dec. 15, 2015 (CN) 201510930822.4

(51) Int. Cl. H04L 12/911; H04L 12/26

(52) U.S. Cl. CPC H04L 47/82; H04L 43/16

(57) ABSTRACT

Embodiments of the present disclosure relate to the field of information technology, and an inter-process communication method and a client implementing the method are disclosed. The method includes: storing, by a first process, signaling in a buffer area, and broadcasting the event to all the other processes; reading, by each of all the other processes, the signaling in the buffer area after receiving the event, and determining whether the signaling is directed to the process; when the signaling is directed to the process, performing an operation indicated by the signaling; when the signaling is not directed to the process, discarding the signaling.

### CROSS-REFERENCE TO RELATED DISCLOSURES

This disclosure is a continuation of PCT application No. PCT/CN2016/089564 submitted on Jul. 10, 2016, which is based upon and claims priority to Chinese Patent Application No. 201510930822.4, filed on Dec. 15, 2015, the entire contents of which are incorporated herein by reference.

### TECHNICAL FIELD

Embodiments of the present disclosure relate to information technology, and more particularly, to an inter-process communication method and an electronic device for implementing the method.

### BACKGROUND

Inter-process communication (IPC) is a set of programming interfaces that allow a programmer to coordinate different processes of a program, such that the processes may run simultaneously in an operating system. In this way, a program may process requests of many users simultaneously. Because a plurality of processes may need to run in the operating system even if there is only one user initiating a request, communication between the processes is needed.

Currently, a commonly used inter-process communication manner is mainly a socket communication manner or a manner in which a registry or a local file is used as an exchange medium. However, such manners have problems in terms of the message transmission speed and flexibility. In addition, because conventional socket communication is carried out through a port, and current hacking technologies mostly steal information through the port, this communication manner further has the disadvantage of low security.

### SUMMARY

On a first aspect, an embodiment of the present disclosure provides an inter-process communication method. The method includes: storing, by a first process, signaling in a buffer area, and broadcasting an event to all the other processes; reading, by each of all the other processes, the signaling in the buffer area after receiving the event, and determining whether the signaling is directed to the process, and when the signaling is directed to the process, performing an operation indicated by the signaling, or when the signaling is not directed to the process, discarding the signaling. The first process may broadcast the event to processes that are associated with the event in all the other processes.

On a second aspect, an embodiment of the disclosure further provides a non-volatile computer storage medium, which stores computer executable instructions, where the computer executable instructions are configured to perform any of the foregoing inter-process communication methods of the disclosure.

On a third aspect, an embodiment of the disclosure further provides an electronic device, including: at least one processor; and a memory, where the memory stores instructions that can be executed by the at least one processor, and the execution of the instructions by the at least one processor causes the at least one processor to perform any of the foregoing inter-process communication methods of the disclosure.

### BRIEF DESCRIPTION OF THE DRAWINGS

One or more embodiments are exemplarily described by figures corresponding thereto in the accompanying drawings, and the exemplary descriptions do not constitute a limitation on the embodiments. Elements with the same reference numbers in the accompanying drawings represent similar elements. Unless otherwise particularly stated, the figures in the accompanying drawings do not constitute a scale limitation. In the accompanying drawings:

FIG. 1 is a flowchart illustrating an inter-process communication method according to an embodiment of the present disclosure; and

FIG. 2 is a schematic structural diagram illustrating a client according to an embodiment of the present disclosure; and

FIG. 3 is a schematic structural diagram of hardware of a device for executing an inter-process communication method according to another embodiment of the present disclosure.

### DETAILED DESCRIPTION

Specific embodiments of the present disclosure are described hereinafter in detail with reference to the accompanying drawings. It should be understood that the specific embodiments described herein are merely used for describing and explaining the present disclosure, and are not used to limit the present disclosure.

Some embodiments of the present disclosure provide an inter-process communication method, including: storing, by a first process, signaling in a buffer area, and broadcasting an event to all the other processes; reading, by each of all the other processes, the signaling in the buffer area after receiving the event, and determining whether the signaling is directed to the process, and when the signaling is directed to the process, performing an operation indicated by the signaling, or when the signaling is not directed to the process, discarding the signaling.

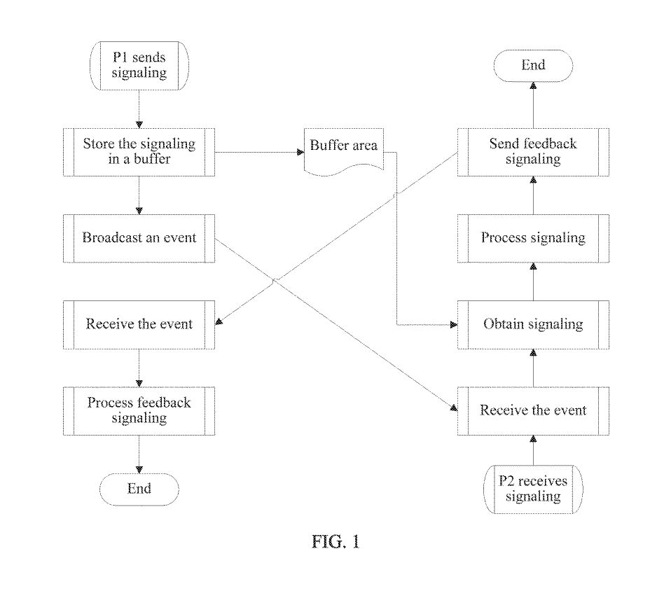

FIG. 1 is a flowchart illustrating an inter-process communication method according to an embodiment of the present disclosure. As illustrated in FIG. 1, a process P1 may send signaling to a process P2. The procedure is specifically: The process P1 stores signaling in a buffer area of a buffer, and broadcasts an event (the event may be an event that may be broadcasted and received by any process) to all the other processes (for example, processes P2 to Pn, where n is an integer greater than or equals to 3). After receiving the event, the process P2 may read the signaling in the buffer area, and determine whether the signaling is directed to the process P2. For example, the process P2 may determine a signaling format of the signaling. If format information of the signaling includes information indicating that “target address” is “P2” (for example, from P1 to P2), the signaling may be considered as aiming at the process P2. Other processes P3 to Pn may also receive the event, read the signaling in the buffer area after receiving the event, and determine whether the signaling is directed to the processes. When the signaling does not aim at the processes P3 to Pn, the processes P3 to Pn may discard the signaling. After determining that the signaling is directed to the process P2, the process P2 may execute the signaling (that is, perform an operation according to the requirements of the signaling, for example, perform an operation such as initialization, termination or display). After executing the signaling, the process P2 may also send feedback signaling to the process P1. The feedback signaling may be handshake information, instructing the process P1 to perform some operations of a next step, or may be information merely notifying the process P1 that the signaling sent by the process P1 has been executed. The manner of sending the feedback signaling is the same as that of sending the signaling by the process P1 to the process P2, that is, the feedback signaling is stored in a buffer area and an event is broadcasted to trigger the process P1 to read the feedback signaling in the buffer area. Definitely, the other processes P3 to Pn in the procedure also receive the event and read the signaling in the buffer area, while discard the signaling when the signaling does not aim at the process P3 to Pn. After reading the feedback signaling and determining that the feedback signaling is directed to the process P1, the process P1 may perform an operation indicated by the feedback signaling.

In an example, the event may be some specific events. The process P1 may broadcast the event to processes that are associated with the event in all the other processes. In this way, the broadcasting range of the event may be narrowed, improving broadcasting efficiency.

To avoid the chaos caused when access operations are performed on the buffer area by different processes, preferably, a locked state indicator is set in the buffer area, so as to indicate whether the buffer area is in a locked state or in an unlocked state. Before a process performs an operation on the buffer area, the process first reads the locked state indicator. When the locked state indicator indicates that the buffer area is in an unlocked state, set the state of the buffer area to a locked state, and perform the operation on the buffer area, thereby preventing other processes from accessing the buffer area in a period when the process accesses the buffer area. When the locked state indicator indicates that the buffer area is in a locked state, the process waits until the locked state indicator indicates that the buffer area is in an unlocked state.

The above operations such as generating and broadcasting an event may use technologies related to event control such as Create Event, Wait For Single Object and Reset Event in the Windows system. For setting a buffer area that allows a plurality of processes to access in a computer memory, technologies related to memory mapping operations such as Open File Mapping, Create File Mapping, Map View Of File and Un map View Of File may be used. For locking and unlocking the buffer area, relevant technologies of locking a critical section such as Create Mutex, Wait For Single Object and Release Mutex may be used. In addition, for a signaling format and operations specifically indicated by the signaling, signaling such as, to, from and cmd of the XMPP protocol may be used.

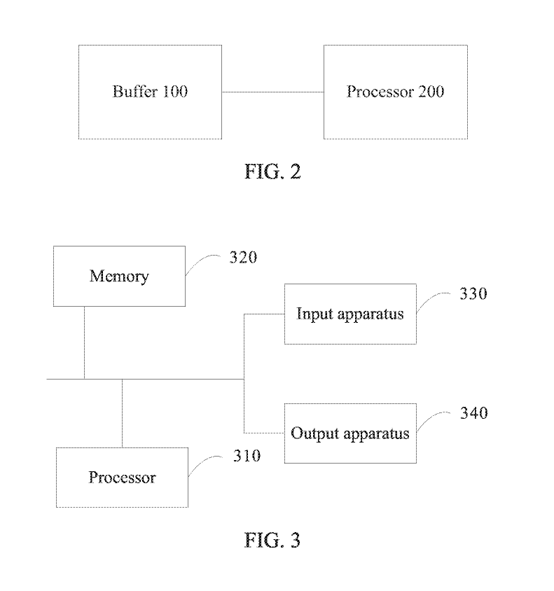

FIG. 2 is a schematic structural diagram of a client according to an embodiment of the present disclosure. As illustrated in FIG. 2, accordingly, the present disclosure further provides a client, including a buffer 100 and a processor 200. The processor 200 executes a plurality of processes simultaneously and is configured to: store, by a first process, signaling to a buffer area of the buffer, and broadcast an event to all the other processes; read, by each of all the other processes, the signaling in the buffer area after receiving the event, and determine whether the signaling is directed to the process, and when the signaling is directed to the process, execute an operation indicated by the signaling, or when the signaling is not directed to the process, discard the signaling. Based on the above, because inter-process communication is performed inside a buffer, transmission speed of information is relatively high, and the information cannot be easily intercepted by hackers, leading to high security.

To narrow the broadcasting range of an event and improve broadcasting efficiency, preferably, the event may be some specific events. The first process may broadcast the event to processes that are associated with the event in all the other processes.

The processor 200 is further configured to: generate, by the process, feedback signaling after performing the operation indicated by the signaling; store the feedback signaling to the buffer area, and broadcast an event to all the other processes; read, by each of all the other processes, the feedback signaling from the buffer area after receiving the event, and determine whether the feedback signaling is directed to the process, and when the feedback signaling does not aim at the process, discard the feedback signaling.

To avoid the chaos caused when access operations are performed on the buffer area by different processes, preferably, a locked state indicator is set in the buffer area, so as to indicate whether the buffer area is in a locked state or in an unlocked state. The processor 200 is further configured to: read, by a process, a state of the buffer area before performing an operation on the buffer area; when the buffer area is in an unlocked state, set the state of the buffer area to a locked state, and perform the operation on the buffer area; when the buffer area is in a locked state, wait until the buffer area is in an unlocked state.

Each of all the other processes determines whether the signaling is directed to the process according to a signaling format of the signaling. For example, the process P2 may determine a signaling format of the signaling. If format information of the signaling includes information indicating that “target address” is “P2” (for example, from P1 to P2), the signaling may be considered as aiming at the process P2; otherwise, the signaling may be discarded.

For specific details and benefits of the operations performed by the processor 200, refer to the above descriptions about the inter-process communication method, and details are not described herein again. The client of the present disclosure may include but is not limited to a PC, mobile phone and tablet computer with the Windows system.

Based on the above technical solutions, because inter-process communication is performed inside a buffer, transmission speed of information is relatively high, and the information cannot be easily intercepted by hackers, leading to high security.

Another embodiment of the disclosure provides a non-volatile computer storage medium, which stores a computer executable instruction, where the computer executable instructions can execute the inter-process communication method of any of the foregoing method embodiments of the disclosure.

FIG. 3 is a schematic structural diagram of hardware of an electronic device for executing an inter-process communication method provided by another embodiment of the disclosure. As shown in FIG. 3, the device includes:

one or more processors 310 and a memory 320, with one processor 310 as an example in FIG. 3.

A device for executing the inter-process communication method may further include: an input apparatus 330 and an output apparatus 340.

The processor 310, the memory 320, the input apparatus 330, and the output apparatus 340 can be connected by means of a bus or in other manners, with a connection by means of a bus as an example in FIG. 3.

As a non-volatile computer readable storage medium, the memory 320 can be used to store non-volatile software programs, non-volatile computer executable programs and modules, for example, program instructions/module corresponding to the inter-process communication method in the embodiments of the disclosure (for example, a buffer 100 and a processor 200 shown in FIG. 2). The processor 310 executes various functional applications and data processing of the server, that is, implements the inter-process communication method of the foregoing method embodiments, by running the non-volatile software programs, instructions, and modules stored in the memory 320.

The memory 320 may include a program storage area and a data storage area, where the program storage area may store an operating system and at least one application needed by function; the data storage area may store data created according to use of an inter-process communication apparatus, and the like. In addition, the memory 320 may include a high-speed random access memory, and also may include a non-volatile memory, such as at least one disk storage device, flash storage device, or other non-volatile solid-state storage devices. In some embodiments, the memory 320 optionally includes memories remotely disposed with respect to the processor 310, and the remote memories may be connected, via a network, to the inter-process communication apparatus. Examples of the foregoing network include but are not limited to: the Internet, an intranet, a local area network, a mobile communications network, and a combination thereof.

The input apparatus 330 can receive entered digit or character information, and generate key signal inputs relevant to user setting and functional control of the inter-process communication apparatus. The output apparatus 340 may include a display device, for example, a display screen, etc.

The one or more modules are stored in the memory 320, and execute the inter-process communication method in any one of the foregoing method embodiments when being executed by the one or more processors 310.

The foregoing product can execute the method provided in the embodiments of the disclosure, and has corresponding functional modules for executing the method and beneficial effects. The method provided in the embodiments of the disclosure can be referred to for technical details that are not described in detail in the embodiment.

The electronic device in the embodiment of the disclosure exists in multiple forms, including but not limited to:

(1) Mobile communication device: such devices being characterized by having a mobile communication function and a primary objective of providing voice and data communications; such type of terminals including a smart phone (for example, an iPhone), a multimedia mobile phone, a feature phone, a low-end mobile phone, and the like;

(2) Ultra mobile personal computer device: such devices belonging to a category of personal computers, having computing and processing functions, and also generally a feature of mobile Internet access; such type of terminals including PDA, MID and UMPC devices, and the like, for example, an iPad;

(3) Portable entertainment device: such devices being capable of display and play multimedia content; such type of devices including an audio and video player (for example, an iPod), a handheld game console, an e-book, an intelligent toy and a portable vehicle-mounted navigation device;

(4) Server: a device that provides a computing service; the components of the server including a processor, a hard disk, a memory, a system bus, and the like; an framework of the server being similar to that of a general-purpose computer, but higher demanding in aspects of processing capability, stability, reliability, security, extensibility, manageability or the like due to a need to provide highly reliable services; and

(5) Other electronic apparatuses having a data interaction function.

The apparatus embodiments described above are merely schematic, and the units described as separated components may or may not be physically separated; components presented as units may or may not be physical units, that is, the components may be located in one place, or may be also distributed on multiple network units. Some or all modules therein may be selected according to an actual requirement to achieve the objective of the solution of the embodiment.

Through descriptions of the foregoing implementation manners, a person skilled in the art can clearly recognize that each implementation manner can be implemented by means of software in combination with a general-purpose hardware platform, and certainly can be also implemented by hardware. Based on such an understanding, the essence or a part contributing to the relevant technologies of the foregoing technical solutions can be embodied in the form of a software product. The computer software product may be stored in a computer readable storage medium, for example, a ROM/RAM, a magnetic disk, a compact disc or the like, including several instructions for enabling a computer device (which may be a personal computer, a sever, or a network device, and the like) to execute the method described in the embodiments or in some parts of the embodiments.

Finally, it should be noted that the foregoing embodiments are only for the purpose of describing the technical solutions of the disclosure, rather than limiting thereon. Although the disclosure has been described in detail with reference to the foregoing embodiments, a person of ordinary skill in the art should understand that he/she can still modify technical solutions disclosed in the foregoing embodiments, or make equivalent replacements to some technical features therein, while such modifications or replacements do not make the essence of corresponding technical solutions depart from the spirit and scope of the technical solutions of the embodiments of the disclosure.

1. An inter-process communication method, comprising:
storing, by a first process, signaling in a buffer area, and broadcasting an event to all the other processes; and
reading, by each of all the other processes, the signaling in the buffer area after receiving the event, determining whether the signaling is directed to the process, and when the signaling is directed to the process, performing an operation indicated by the signaling; when the signaling is not directed to the process, discarding the signaling.

2. The method according to claim 1, wherein the first process broadcasts the event to processes that are associated with the event in all the other processes.

3. The method according to claim 1, further comprising:
generating, by the process, feedback signaling after performing the operation indicated by the signaling, storing the feedback signaling to the buffer area, and broadcasting an event to all the other processes; and
reading, by each of all the other processes, the feedback signaling in the buffer area after receiving the event, determining whether the feedback signaling is directed to the process, and when the feedback signaling does not aim at the process, discarding the signaling.

4. The method according to claim 1, further comprising:
reading, by a process, a state of the buffer area before performing an operation on the buffer area;
when the buffer area is in an unlocked state, setting the state of the buffer area to a locked state, and performing the operation on the buffer area; or when the buffer area is in a locked state, waiting until the buffer area is in an unlocked state.

5. The method according to claim 1, wherein each of all the other processes determines whether the signaling is directed to the process according to a signaling format of the signaling.

6-10. (canceled)

11. A non-volatile computer storage medium, which stores computer executable instructions, where the computer executable instructions are configured to:
store, by a first process, signaling in a buffer area, and broadcasting an event to all the other processes; and
read, by each of all the other processes, the signaling in the buffer area after receiving the event, determine whether the signaling is directed to the process, and when the signaling is directed to the process, perform an operation indicated by the signaling; when the signaling is not directed to the process, discard the signaling.

12. The non-volatile computer storage medium according to claim 11, wherein the first process broadcasts the event to processes that are associated with the event in all the other processes.

13. The non-volatile computer storage medium according to claim 11, where the computer executable instructions are further configured to:
generate, by the process, feedback signaling after performing the operation indicated by the signaling, store the feedback signaling to the buffer area, and broadcast an event to all the other processes; and
read, by each of all the other processes, the feedback signaling in the buffer area after receiving the event, determine whether the feedback signaling is directed to the process, and when the feedback signaling does not aim at the process, discard the signaling.

14. The non-volatile computer storage medium according to claim 11, where the computer executable instructions are further configured to:
read, by a process, a state of the buffer area before performing an operation on the buffer area;
when the buffer area is in an unlocked state, set the state of the buffer area to a locked state, and perform the operation on the buffer area; or when the buffer area is in a locked state, wait until the buffer area is in an unlocked state.

15. The non-volatile computer storage medium according to claim 11, wherein each of all the other processes determines whether the signaling is directed to the process according to a signaling format of the signaling.

16. An electronic device, comprising:
at least one processor; and
a memory in communication connection with the at least one processor, where the memory stores instructions that can be executed by the at least one processor, and the execution of the instructions by the at least one processor causes the at least one processor to:
store, by a first process, signaling in a buffer area, and broadcast an event to all the other processes; and
read, by each of all the other processes, the signaling in the buffer area after receiving the event, determine whether the signaling is directed to the process, and when the signaling is directed to the process, perform an operation indicated by the signaling; when the signaling is not directed to the process, discard the signaling.

17. The electronic device according to claim 16, wherein the first process broadcasts the event to processes that are associated with the event in all the other processes.

18. The electronic device according to claim 16, where the at least one processor is further caused to:
generate, by the process, feedback signaling after performing the operation indicated by the signaling, store the feedback signaling to the buffer area, and broadcast an event to all the other processes; and
read, by each of all the other processes, the feedback signaling in the buffer area after receiving the event, determine whether the feedback signaling is directed to the process, and when the feedback signaling does not aim at the process, discard the signaling.

19. The electronic device according to claim 16, where the at least one processor is further caused to:
read, by a process, a state of the buffer area before performing an operation on the buffer area;
when the buffer area is in an unlocked state, set the state of the buffer area to a locked state, and perform the operation on the buffer area; or when the buffer area is in a locked state, wait until the buffer area is in an unlocked state.

20. The electronic device according to claim 16, wherein each of all the other processes determines whether the signaling is directed to the process according to a signaling format of the signaling.
